(19) United States
(12) Patent Application Publication
(10) Pub. No.: US 2025/0278652 A1
(43) Pub. Date: Sep. 4, 2025

(54) QUANTUM CHIP AND QUANTUM COMPUTING DEVICE

(71) Applicant: YANGTZE DELTA INDUSTRIAL INNOVATION CENTER OF QUANTUM SCIENCE AND TECHNOLOGY, Suzhou (CN)

(72) Inventors: Yuwei MA, Suzhou (CN); Xuan YU, Suzhou (CN); Xiang ZHANG, Suzhou (CN); Yongchao LI, Suzhou (CN); Pengju TANG, Suzhou (CN)

(21) Appl. No.: 18/796,354

(22) Filed: Aug. 7, 2024

Related U.S. Application Data
(63) Continuation of application No. PCT/CN2022/135592, filed on Nov. 30, 2022.

(30) Foreign Application Priority Data
Sep. 9, 2022 (CN) 202211102369.4

(51) Int. Cl. G06N 10/20; G06N 10/40

(52) U.S. Cl. CPC G06N 10/20; G06N 10/40

(57) ABSTRACT

A quantum chip and a quantum computing device are applied to the field of quantum computing technologies. The quantum chip includes a first substrate and a second substrate arranged oppositely, where a reading cavity is formed on a side surface of the first substrate facing the second substrate, a quantum bit corresponding to the reading cavity is disposed on a side surface of the second substrate facing the first substrate, and the reading cavity and the quantum bit are mutually coupled by forming a capacitor therebetween. Structures of a quantum chip body are disposed on two opposite surfaces respectively, and structural components on the two surfaces are mutually coupled to form the quantum chip body, which may reduce the number of the structural components disposed in any surface, thereby lowering the wiring difficulty of the structures of the quantum chip body in any surface

### CROSS-REFERENCE TO RELATED APPLICATIONS

The present application is a continuation of International Application No. PCT/CN2022/135592, with an international filing date of Nov. 30, 2022, which is based upon and claims priority to Chinese Patent Application No. 202211102369.4, filed on Sep. 9, 2022, the entire contents of all of which are incorporated herein by reference.

### TECHNICAL FIELD

The present disclosure relates to the field of quantum computing technologies, in particular to a quantum chip and a quantum computing device.

### BACKGROUND

At present, the mainstream superconducting quantum chip is of a single-sided planar structure, especially when there is a small number of quantum bits. In this way, the equivalent distance between a quantum bit and a reading cavity is limited to a large value when they are on the same surface. Because electromagnetic oscillation modes of the quantum bit and the reading cavity are both localized near structures, a capacitor between the quantum bit and the reading cavity, that is, the coupling strength, is difficult to increase. The typical coupling strength is below 100 MHz. In the application of quantum chips, especially in quantum error correction, fast and high-fidelity quantum state reading is required in many cases, which requires high coupling strength between the reading cavity and the quantum bit. With the increase in the number of quantum bits, the size of the chip increases progressively. A coplanar structure of the reading cavity and the bit as basic units will occupy a large area, which makes it difficult to reduce the size of the chip, thus encountering difficulties such as an encapsulation box mode limiting the bit performance. Therefore, how to lower the wiring difficulty of the quantum chip in case of a large number of quantum bits is an urgent problem to be solved by those skilled in the art.

### SUMMARY

An objective of the present disclosure is to provide a quantum chip with low wiring difficulty. Another objective of the present disclosure is to provide a quantum computing device with low wiring difficulty.

To solve the above technical problems, the present disclosure provides a quantum chip, including a first substrate and a second substrate arranged oppositely,
where a reading cavity is formed on a side surface of the first substrate facing the second substrate, a quantum bit corresponding to the reading cavity is disposed on a side surface of the second substrate facing the first substrate, and the reading cavity and the quantum bit are mutually coupled by forming a capacitor therebetween.

Optionally, a plurality of quantum bits are disposed on a surface of the second substrate, the plurality of quantum bits are distributed in an array, and a coupler is disposed between adjacent two of the quantum bits.

Optionally, the coupler and the quantum bits are both disposed on the side surface of the second substrate facing the first substrate.

Optionally, a coupler driving line is further included, where the coupler driving line and the reading cavity are both disposed on the side surface of the first substrate facing the second substrate; and the coupler driving line is coupled to the corresponding coupler.

Optionally, the coupler is a capacitive coupler or an inductive coupler.

Optionally, a quantum bit driving line is further included, where the quantum bit driving line and the reading cavity are both disposed on the side surface of the first substrate facing the second substrate; and the quantum bit driving line is coupled to an input terminal corresponding to the quantum bit.

Optionally, the quantum bit driving line is a driving line that simultaneously transmits a direct current signal and a microwave signal.

Optionally, the first substrate is bonded to the second substrate, and a gap is formed between the reading cavity and the quantum bit.

Optionally, the quantum bit is an Xmon quantum bit, and a transverse edge of the Xmon quantum bit overlaps with at least part of a waveguide line predisposed in the reading cavity.

The present disclosure further provides a quantum computing device, including the quantum chip according to any one of the foregoing.

A quantum chip provided by the present disclosure includes a first substrate and a second substrate arranged oppositely, where a reading cavity is formed on a side surface of the first substrate facing the second substrate, a quantum bit corresponding to the reading cavity is disposed on a side surface of the second substrate facing the first substrate, and the reading cavity and the quantum bit are mutually coupled by forming a capacitor therebetween.

Structures of a quantum chip body are disposed on two opposite surfaces respectively, and structural components on the two surfaces are mutually coupled to form the quantum chip body, which may reduce the number of the structural components disposed in any surface, thereby lowering the wiring difficulty of the structures of the quantum chip body in any surface.

Meanwhile, the reading cavity and the quantum bit are mutually coupled by forming the capacitor therebetween in a thickness direction, which may greatly increase the coupling strength between the reading cavity and the quantum bit, and improve the performance of the quantum bit.

The present disclosure further provides a quantum computing device, which also has the above beneficial effects, so they will not be repeated herein.

### BRIEF DESCRIPTION OF THE DRAWINGS

To more clearly illustrate the technical solutions in the embodiments of the present disclosure or in the prior art, the accompanying drawings that need to be used in the description of the embodiments or the prior art will be briefly described below. Apparently, the accompanying drawings in the description below merely illustrate some embodiments of the present disclosure. Those of ordinary skill in the art may also derive other accompanying drawings from these accompanying drawings without creative efforts.

FIG. 1 is a schematic structural diagram of a quantum chip provided by an embodiment of the present disclosure;

FIG. 2 is a schematic structural diagram of a surface of a first substrate in FIG. 1;

FIG. 3 is a schematic structural diagram of a surface of a second substrate in FIG. 1; and

FIG. 4 is a schematic structural diagram of a first specific quantum chip provided by an embodiment of the present disclosure.

In the drawings: 1. reading cavity; 2. quantum bit; 3. coupler; 4. coupler driving line; 5. quantum bit driving line; and 6. reading transmission line.

### DESCRIPTION OF THE EMBODIMENTS

A core of the present disclosure is to provide a quantum chip. In the prior art, in an existing mode of coupling between a reading cavity and a quantum bit, the reading cavity and the quantum bit are coplanar, and they are capacitively coupled by an interdigital capacitor or in a similar manner. However, with the increase in the number of quantum bits, the size of the chip increases progressively. A coplanar structure of the reading cavity and the bit as basic units will occupy a large area, which makes it difficult to reduce the size of the chip, thus encountering difficulties such as an encapsulation box mode limiting the bit performance.

A quantum chip provided by the present disclosure includes a first substrate and a second substrate arranged oppositely, where a reading cavity is formed on a side surface of the first substrate facing the second substrate, a quantum bit corresponding to the reading cavity is disposed on a side surface of the second substrate facing the first substrate, and the reading cavity and the quantum bit are mutually coupled by forming a capacitor therebetween.

Structures of a quantum chip body are disposed on two opposite surfaces respectively, and structural components on the two surfaces are mutually coupled to form the quantum chip body, which may reduce the number of the structural components disposed in any surface, thereby lowering the wiring difficulty of the structures of the quantum chip body in any surface.

Meanwhile, the reading cavity and the quantum bit are mutually coupled by forming the capacitor therebetween in a thickness direction, which may greatly increase the coupling strength between the reading cavity and the quantum bit, and improve the performance of the quantum bit.

In order to enable those skilled in the art to better understand the solutions of the present disclosure, the present disclosure is further described in detail below in conjunction with the accompanying drawings and specific embodiments. Apparently, the described embodiments are merely some rather than all of the embodiments of the present disclosure. All other embodiments obtained by those of ordinary skill in the art based on the embodiments of the present disclosure without creative efforts shall fall within the scope of protection of the present disclosure.

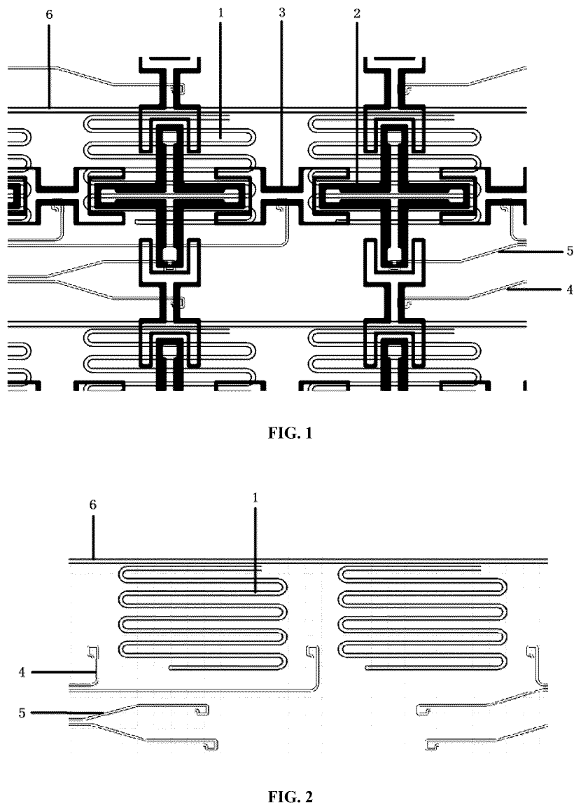

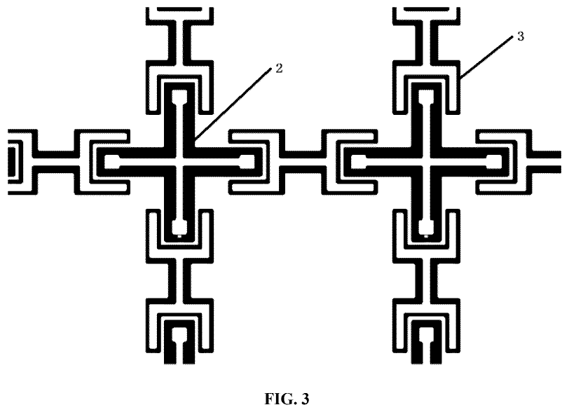

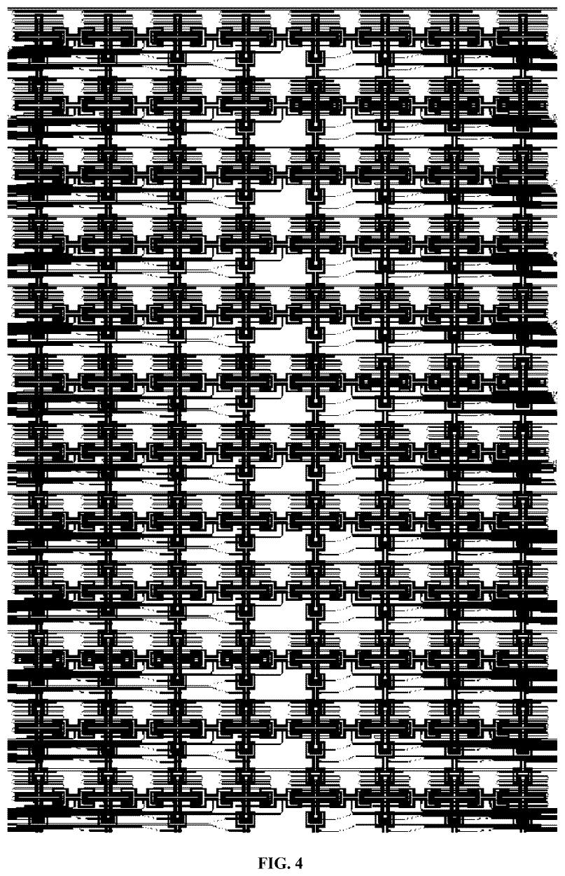

Reference is made to FIG. 1 to FIG. 4, where FIG. 1 is a schematic structural diagram of a quantum chip provided by an embodiment of the present disclosure; FIG. 2 is a schematic structural diagram of a surface of a first substrate in FIG. 1; FIG. 3 is a schematic structural diagram of a surface of a second substrate in FIG. 1; and FIG. 4 is a schematic structural diagram of a first specific quantum chip provided by an embodiment of the present disclosure.

Referring to FIG. 1, in this embodiment of the present disclosure, a quantum chip includes a first substrate and a second substrate arranged oppositely, where a reading cavity 1 is formed on a side surface of the first substrate facing the second substrate, a quantum bit 2 corresponding to the reading cavity 1 is disposed on a side surface of the second substrate facing the first substrate, and the reading cavity 1 and the quantum bit 2 are mutually coupled by forming a capacitor therebetween.

The first substrate and the second substrate jointly provide two opposite surfaces. In this embodiment of the present disclosure, structures will be disposed on the two surfaces, and structural components disposed on the two surfaces will be mutually coupled to form a quantum chip body, thereby implementing a quantum computing function. The quantum chip body, that is, a component that needs to be formed after the structural components on the two surfaces are mutually coupled, includes a reading cavity 1, a quantum bit 2, and a signal line. The reading cavity 1, the quantum bit 2, and the signal line usually also need to be correspondingly coupled to together form the quantum chip body.

The first substrate and the second substrates are substrates for disposing the structures, usually sapphire or silicon substrates. Specific materials of the first substrate and the second substrate are not specifically limited in this embodiment of the present disclosure and depend on specific circumstances. In this embodiment of the present disclosure, the first substrate and the second substrate need to be bonded to each other. The first substrate and the second substrate may be bonded to each other by means of a flip chip bonding process. An indium column may be disposed as a support structure and an electrical connection for the ground plane between the first substrate and the second substrate.

The quantum bit 2 is a physical system for providing an operable and measurable quantum state. In a superconducting quantum computing chip, a superconducting system with a Josephson junction as a core element is generally used as the quantum bit 2 such as a Transmon bit; the reading cavity 1 is usually used to read a state of the quantum bit 2, and is generally a quarter-wavelength coplanar waveguide cavity; and the signal line is specifically used to transmit a signal including a direct current signal and a microwave signal.

Referring to FIG. 2 and FIG. 3, in this embodiment of the present disclosure, the reading cavity 1 will be disposed as a complete structure on a surface of the first substrate, and the quantum bit 2 will be disposed as another complete structure on a surface of the second substrate. At this time, the quantum bit 2 usually has the corresponding reading cavity 1. The corresponding quantum bit 2 and reading cavity 1 are located on the surface of the first substrate and the surface of the second substrate respectively, and the corresponding reading cavity 1 and quantum bit 2 need to be mutually coupled by forming the capacitor which is usually a planar capacitor therebetween, so the corresponding reading cavity 1 and quantum bit 2 need to be aligned with each other, which makes it possible for a large area of overlap between the corresponding reading cavity 1 and quantum bit 2, resulting in high coupling strength between the corresponding reading cavity 1 and quantum bit 2. Electromagnetic oscillation modes of the quantum bit 2 and the reading cavity 1 are both localized near the structures, so central regions of the quantum bit and the reading cavity may be disposed oppositely by disposing the reading cavity 1 and the quantum bit 2 on the surface of the first substrate and the surface of the second substrate respectively by the structures, which further improves the coupling strength between the quantum bit 2 and the reading cavity 1.

In this embodiment of the present disclosure, it is usually needed to form a gap between the reading cavity 1 and the quantum bit 2. Usually, when the first substrate and the second substrate are bonded to each other, the gap may be formed between the reading cavity 1 and the quantum bit 2, such that the capacitor is formed between the corresponding reading cavity 1 and quantum bit 2 to be coupled. The gap is usually a vacuum gap, and the width of the gap is usually not greater than 10 μm and is usually between 7 μm and 10 μm, including an endpoint value.

Usually, a plurality of quantum bits 2 are disposed on a surface of the second substrate, the plurality of quantum bits 2 are distributed in an array, and a coupler 3 is disposed between adjacent two of the quantum bits 2. The coupler 3 is an element that may be configured to adjust the coupling strength between two quantum bits 2. The plurality of quantum bits 2 are distributed in an array, and the coupler 3 is disposed between adjacent two of the quantum bits 2, such that a quantum bit 2 array may be formed. Then, calculation is made based on the quantum bit 2 array. The coupler 3 may be a capacitive coupler 3 or an inductive coupler 3. A specific structure of the coupler 3 may be set according to an actual situation and is not specifically limited herein.

Specifically, in this embodiment of the present disclosure, the coupler 3 and the quantum bits 2 are both disposed on the side surface of the second substrate facing the first substrate. In order to facilitate coupling between the adjacent quantum bits 2 by the coupler 3, the coupler 3 is usually located on the same surface as the quantum bit 2, that is, the coupler 3 and the quantum bit 2 are both disposed on the side surface of the second substrate facing the first substrate. Correspondingly, in this embodiment of the present disclosure, the reading cavity 1 and the signal line will be disposed on the side surface of the first substrate facing the second substrate.

In this embodiment of the present disclosure, the signal line further includes a coupler driving line 4, where the coupler driving line 4 and the reading cavity 1 are both disposed on the side surface of the first substrate facing the second substrate; and the coupler driving line 4 is coupled to the corresponding coupler 3.

The signal line usually includes a driving line and a reading transmission line 6, where the driving line is usually a transmission line for operating the state of the quantum bit 2, and is used to drive the quantum bit 2 to generate the corresponding state; and the reading transmission line 6 is used to read the signal from the reading cavity 1. The driving line specifically includes a coupler driving line 4 and a quantum bit driving line 5, where the coupler driving line 4 and the reading cavity 1 are both disposed on the side surface of the first substrate facing the second substrate, and the coupler driving line 4 has the corresponding coupler 3. The coupler driving line 4 will be coupled to the corresponding coupler 3 to implement control on the coupler 3, thereby implementing control on the signal transmitted between the quantum bits 2. In this embodiment of the present disclosure, specifically, the coupler driving line 4 and the coupler 3 will be coupled by forming an inductor or a capacitor therebetween to control the transmitted signal.

Optionally, the signal line further includes a quantum bit driving line 5, where the quantum bit driving line 5 and the reading cavity 1 are both disposed on the side surface of the first substrate facing the second substrate; and the quantum bit driving line 5 is coupled to an input terminal corresponding to the quantum bit 2. The quantum bit driving line 5 is used to control the signal transmitted by the quantum bit 2 itself.

The quantum bit driving line 5 needs to be disposed on the surface of the first substrate along with the reading cavity 1, and the quantum bit driving line 5 has the corresponding quantum bit 2. The quantum bit driving line 5 needs to be coupled to the corresponding quantum bit 2, specifically the input terminal corresponding to the quantum bit 2, so as to control the transmitted signal. In this embodiment of the present disclosure, specifically, the quantum bit driving line 5 and the quantum bit 2 will be coupled by forming an inductor or a capacitor therebetween, so as to control the transmitted signal.

Specifically, the signal transmitted from the quantum bit driving line 5 to the quantum bit 2 usually includes the direct current signal and the microwave signal. In the prior art, one quantum bit 2 usually corresponds to two quantum bit driving lines 5 in which one is used to transmit the direct current signal and the other is used to transmit the microwave signal, that is, the quantum bit driving line 5 may specifically include a line XY and a line Z. In this embodiment of the present disclosure, the quantum bit driving line 5 is a driving line that simultaneously transmits the direct current signal and the microwave signal, that is, the line XY and the line Z may be combined into one signal line; and the quantum bit driving line 5 may simultaneously transmit the direct current signal and the microwave signal based on its own circuit design, such that the existing two quantum bit driving lines 5 may be integrated into one quantum bit driving line 5, that is, in this embodiment of the present disclosure, one quantum bit 2 corresponds to only one quantum bit driving line 5, and the quantum bit driving line 5 may simultaneously transmit the direct current signal and the microwave signal.

In this embodiment of the present disclosure, the signal line further includes a reading transmission line 6, where the reading transmission line 6 and the reading cavity 1 are both disposed on the side surface of the first substrate facing the second substrate; and the reading transmission line 6 is coupled to the reading cavity 1. The reading transmission line 6 is used to read the signal from the reading cavity 1, so as to identify the state of the quantum bit 2. The reading transmission line 6 and the reading cavity 1 are both located on the surface of the first substrate, and the reading transmission line 6 needs to be connected to the reading cavity 1. In this embodiment of the present disclosure, the reading transmission line 6 may be specifically connected to a bandpass filter, thereby improving the accuracy of reading the state of the quantum bit 2.

In this embodiment of the present disclosure, the quantum bit 2 is usually a Transmon quantum bit 2, and is specifically of a ground structure or a floating structure. Preferably, the quantum bit 2 is an Xmon quantum bit 2, and a transverse edge of the Xmon quantum bit 2 overlaps with at least part of a waveguide line predisposed in the reading cavity 1. The Xmon quantum bit 2 may be regarded as a type of Transmon quantum bit 2, is usually in a cruciform structure, and usually has a transverse edge. In this embodiment of the present disclosure, the reading cavity 1 is usually formed in a manner that a plurality of waveguide lines are arranged in parallel on the surface of the first substrate and communicated by bent portions. In this embodiment of the present disclosure, the transverse edge of the Xmon quantum bit 2 overlaps with at least part of a waveguide line predisposed in the reading cavity 1, which may further increase the coupling strength between the quantum bit 2 and the reading cavity 1.

The so-called overlap means that an axis of the transverse edge of the Xmon quantum bit 2 roughly overlaps with an axis of the waveguide line predisposed in the reading cavity 1, such that there is a large area of overlap between the transverse edge of the Xmon quantum bit 2 and the waveguide line predisposed in the reading cavity 1. The so-called partial overlap means that there may be a certain difference between the length of the transverse edge of the Xmon quantum bit 2 and the length of the waveguide line predisposed in the reading cavity 1, or a certain angle will be formed between the transverse edge of the Xmon quantum bit 2 and the waveguide line predisposed in the reading cavity 1, such that there will only be partial overlap between the transverse edge of the Xmon quantum bit 2 and the waveguide line predisposed in the reading cavity 1, rather than complete overlap. The so-called at least partial overlap means that in this embodiment of the present disclosure, the length of the transverse edge of the Xmon quantum bit 2 and the length of the waveguide line predisposed in the reading cavity 1 are not restricted and may have a certain difference or be roughly equal; and in this embodiment of the present disclosure, it is not required that the transverse edge of the Xmon quantum bit 2 is completely parallel to the waveguide line predisposed in the reading cavity 1 until now, and there may be a certain angle between them. When the transverse edge of the Xmon quantum bit 2 is basically parallel to the waveguide line predisposed in the reading cavity 1 and their lengths are roughly equal, it may be regarded that the transverse edge of the Xmon quantum bit 2 completely overlaps with the waveguide line predisposed in the reading cavity 1. At this time, there is high coupling strength between the quantum bit 2 and the reading cavity 1.

Referring to FIG. 4, in this embodiment of the present disclosure, the structures are sufficient to support large-scale fabrication of quantum bit 2 chips. FIG. 4 shows a schematic diagram of an (8×16=128)-bit chip fabricated based on the structures. When in use, the quantum chip needs to be first placed into a dilution refrigerator. First, the bit is initialized to be in a ground state by means of natural cooling or measurement feedback. Then, low-frequency signals or microwave signals are applied to the signal line to implement different quantum gates for quantum computing. Finally, microwave signals in one-to-one correspondence with frequencies of the reading cavity 1 are inputted on the reading transmission line 6, such that states of all quantum bits 2 can be read at a time. The use of the quantum chip can implement reading time of a hundred of nanoseconds, and the coupling strength exceeding 100 MHz may be formed between the quantum bit 2 and the reading cavity 1 due to the structures.

According to the quantum chip provided by this embodiment of the present disclosure, the quantum bit 2 and the reading cavity 1 are usually disposed on the two surfaces and oppositely coupled, which may greatly increase the coupling strength between the quantum bit 2 and the reading cavity 1, and lower the wiring difficulty of the structures of the quantum chip body in any surface.

The remaining structures of a quantum chip provided by the present disclosure will be described in detail in the following embodiment of the disclosure.

Different from the above embodiment of the present disclosure, this embodiment of the present disclosure further specifically defines the structures of the quantum chip on the basis of the above embodiment of the present disclosure. The remaining content has been described in detail in the above embodiment of the present disclosure, and will not be repeated herein.

In this embodiment of the present disclosure, the first structural component and the second structural component are mutually coupled to form the quantum bit 2 and/or the reading cavity 1. That is, in this embodiment of the present disclosure, specifically, the structure of the quantum bit 2 itself or the structure of the reading cavity 1 itself may be split, and subcomponents obtained by splitting are disposed in the first structural component and the second structural component respectively, such that the first structural component and the second structural component may be mutually coupled to form the quantum bit 2 and/or the reading cavity 1.

For example, in this embodiment of the present disclosure, when the quantum bit 2 specifically includes capacitor plates oppositely disposed along the thickness direction, the oppositely disposed capacitor plates may be disposed on the surface of the first substrate facing the second substrate and the surface of the second substrate facing the first substrate respectively. When the first substrate and the second substrate are bonded to each other, the capacitor plates disposed on the two surfaces may form one complete quantum bit 2, thereby lowering the difficulty of wiring on the surface of the single substrate.

In this embodiment of the present disclosure, the reading cavity 1 is usually formed in a manner that the plurality of waveguide lines are arranged in parallel on the surface of the first substrate and communicated by the bent portions, so for the reading cavity 1, the waveguide lines and the bent portions may be disposed on the surface of the first substrate facing the second substrate and the surface of the second substrate facing the first substrate respectively. When the first substrate and the second substrate are bonded to each other, the waveguide lines and the bent portions disposed on the two surfaces are mutually coupled to form one complete reading cavity 1, thereby lowering the difficulty of wiring on the surface of the single substrate.

Certainly, in this embodiment of the present disclosure, the signal lines with different functions may also be disposed on the surface of the first substrate facing the second substrate and the surface of the second substrate facing the first substrate respectively, thereby lowering the difficulty of wiring on the surface of the single substrate. The components split on two different surfaces may be combined arbitrarily, as long as the complete quantum chip body may be formed when the first substrate and the second substrate are bonded.

According to a quantum chip provided by an embodiment of the present disclosure, structures of a quantum chip body are disposed on two opposite surfaces respectively, and structural components on the two surfaces are mutually coupled to form the quantum chip body, which may reduce the number of the structural components disposed in any surface, thereby lowering the wiring difficulty of the structures of the quantum chip body in any surface.

The remaining structures of a quantum chip provided by the present disclosure will be described in detail in the following embodiment of the disclosure.

Different from the above embodiment of the present disclosure, this embodiment of the present disclosure further specifically defines the structures of the quantum chip on the basis of the above embodiment of the present disclosure. The remaining content has been described in detail in the above embodiment of the present disclosure, and will not be repeated herein.

In this embodiment of the present disclosure, the reading cavity 1 and the quantum bit 2 are located on the side surface of the first substrate facing the second substrate, and the signal line is located on the side surface of the second substrate facing the first substrate. At this time, the reading cavity 1 and the quantum bit 2 are located on one surface, and the signal line is located on the other surface. The reading cavity 1 and the quantum bit 2 located on the same surface may be capacitively coupled by an interdigital capacitor or in a similar manner, and the signal line disposed on the other surface has high flexibility in layout due to no structural constraints of the reading cavity 1 and the quantum bit 2 themselves, thereby lowering the wiring difficulty thereof as much as possible.

According to a quantum chip provided by an embodiment of the disclosure, the signal line is separately disposed on one surface and separated from the reading cavity 1 and the quantum bit 2, such that the signal line has high flexibility in layout, thereby lowering the wiring difficulty thereof as much as possible.

The present disclosure further provides a quantum computing device, which needs to include the quantum chip according to any one of the above embodiments. For the remaining structures of the quantum computing device, such as a dilution refrigerator, specifically, reference may be made to the prior art, and further description will not be provided herein.

A quantum chip provided by an embodiment of the present disclosure has low wiring difficulty and thus may have low fabrication cost, so a quantum computing device provided by an embodiment of the present disclosure may usually have low wiring difficulty and thus has low fabrication cost.

Herein, the embodiments are described progressively. Each embodiment focuses on the differences from other embodiments. The same or similar parts in the embodiments may be referred to each other.

Finally, it is also to be noted that herein, the relational terms such as first and second are only used to distinguish one entity or operation from another entity or operation, and do not necessarily require or imply any such actual relationship or order among these entities or operations. Moreover, the term “comprise/include”, “contain” or any other variant thereof is intended to cover a non-exclusive inclusion, such that a process, a method, an object or a device including a series of elements not only includes those elements, but also includes other elements not explicitly listed, or further includes elements inherent to such process, method, object or device. Without further limitations, an element defined by the phrase “includes one . . . ” does not exclude the presence of additional identical elements in the process, method, object or device including the element.

A quantum chip and a quantum computing device provided by the present disclosure are described in detail above. Herein, the principles and embodiments of the preset disclosure are illustrated with specific examples. The description of the above embodiments is only used to help understand the method and core idea of the present disclosure. It is to be pointed out that those of ordinary skill in the technical field may make several improvements and modifications to the present disclosure without departing from the principles of the present disclosure, and these improvements and modifications also fall within the scope of protection of the claims of the present disclosure.

What is claimed is:

1. A quantum chip, comprising a first substrate and a second substrate arranged oppositely,
wherein a reading cavity is formed on a side surface of the first substrate facing the second substrate, a quantum bit corresponding to the reading cavity is disposed on a side surface of the second substrate facing the first substrate, and the reading cavity and the quantum bit are mutually coupled by forming a capacitor therebetween.

2. The quantum chip according to claim 1, wherein a plurality of quantum bits are disposed on a surface of the second substrate, the plurality of quantum bits are distributed in an array, and a coupler is disposed between adjacent two of the quantum bits.

3. The quantum chip according to claim 2, wherein the coupler and the quantum bits are both disposed on the side surface of the second substrate facing the first substrate.

4. The quantum chip according to claim 3, further comprising a coupler driving line, wherein the coupler driving line and the reading cavity are both disposed on the side surface of the first substrate facing the second substrate; and the coupler driving line is coupled to the corresponding coupler.

5. The quantum chip according to claim 4, wherein the coupler is a capacitive coupler or an inductive coupler.

6. The quantum chip according to claim 1, further comprising a quantum bit driving line, wherein the quantum bit driving line and the reading cavity are both disposed on the side surface of the first substrate facing the second substrate; and the quantum bit driving line is coupled to an input terminal corresponding to the quantum bit.

7. The quantum chip according to claim 6, wherein the quantum bit driving line is a driving line that simultaneously transmits a direct current signal and a microwave signal.

8. The quantum chip according to claim 1, wherein the first substrate is bonded to the second substrate, and a gap is formed between the reading cavity and the quantum bit.

9. The quantum chip according to claim 1, wherein the quantum bit is an Xmon quantum bit, and a transverse edge of the Xmon quantum bit overlaps with at least part of a waveguide line predisposed in the reading cavity.

10. A quantum computing device, comprising the quantum chip according to claim 1.
